(19) United States
(12) Patent Application Publication
(10) Pub. No.: US 2009/0187599 A1
(43) Pub. Date: Jul. 23, 2009

(54) Generating identity values in a multi-host database management system

(76) Inventors: Kelsey L. Bruso, Minneapolis, MN (US); James M. Plasek, Shoreview, MN (US); Gary W. Roettger, Stillwater, MN (US)

Correspondence Address: UNISYS CORPORATION, Unisys Way, Mail Station E8-114, Blue Bell, PA, 19424, US

(21) Appl. No.: 12/009,947

(22) Filed: Jan. 23, 2008

(51) Int. Cl. G06F 17/30

(52) U.S. Cl. 707/200; 707/E17.005

(57) ABSTRACT

Various approaches for generating key values in a database that is shared in a multi-host data processing arrangement. According to an example method, a shared sequence control structure contains a next key value. Mutually exclusive update access to the sequence control structure is provided for a plurality of instances of a database management system (DBMS) executing on the multi-host data processing arrangement. For a request for a new key value for a database record, a temporary copy of the next key value from the sequence control structure is stored, the sequence control structure is updated with a new next key value, and temporary copy of the next key value is stored as the new key value of the database record.

### FIELD OF THE INVENTION

The present invention generally relates to multi-host database management systems.

### BACKGROUND

A B+tree data structure is often used to manage database records. In an example implementation, leaves of the B+tree are data pages of database records, and parents of the leaves are index pages. The index pages contain primary key values for referencing records in the data pages. The leaves are sequentially linked to provide sequential access to database records. It will be appreciated that different terminology may be used in referring to the data and index pages in a B+tree and may depend on the underlying storage architecture. For example, blocks or some other term may be used instead of pages.

Relational databases generally require that every record be uniquely identified by one or a combination of columns. The one or more columns that uniquely identify records is declared to be the primary key (PK) of the table. In some applications a pre-assigned key, for example, a social security number, is used as the primary key for the records in the table. In other applications, the primary key may be generated as a monotonically increasing value (e.g., 1, 2, 3). The pattern of the primary key sequence may be declared as part of the database definition. For example, the key column may be declared or defined as an IDENTITY column or as a SEQUENCE IDENTITY and SEQUENCE are example designations used in the structured query language (SQL) to identify key values are to be generated by the database management system (DBMS) or by the application program in sequential order.

A database may be shared by applications accessing the database through multiple instances of the DBMS. Where each key is generated as a monotonically increasing value for data shared amongst multiple DBMS instances, each DBMS instance may generate its own sequence of key values and prefix each key with an instance-specific identifier. This provides unique sequential key values in the shared database for the DBMS instances. However, since each DBMS instance has its own sequence, determining the order of insertion based only on the key value is not feasible. It may also be difficult to find the last record of a sequence from each DBMS instance because all the prefixes used by all the DBMS instances must be known.

The manner in which the key sequence is managed may also complicate database recovery. For example, the sequence information may be maintained in a log file as records having the keys in the sequence that are committed. If a system failure occurs after the time that the key value is committed to a record in the database but before the key value is logged, the log file and the database may be out of sync. Or the log file and the database may be in sync, but the database administrator may make a mistake during recovery and cause the resultant database and sequence information to be out of sync following the recovery. This creates the possibility of inserting a record having a key that is a duplicate of a key of a record already present in the database.

A method and system that addresses these and other related issues is therefore desirable.

### SUMMARY

The various embodiments of the invention provide methods and systems for generating key values in a database that is shared in a multi-host data processing arrangement. In one embodiment, a method comprises storing a sequence control structure including a next key value. Mutually exclusive update access is provided to the sequence control structure for a plurality of instances of a database management system (DBMS) executing on the multi-host data processing arrangement. For a request for a new key value for a database record, a temporary copy of the next key value from the sequence control structure is stored, the sequence control structure is updated with a new next key value after storing the temporary copy, and the temporary copy of the next key value is stored as the new key value of the database record after updating the sequence control structure.

In another embodiment, an apparatus is provided for generating key values in a database that is shared in a multi-host data processing arrangement. The apparatus includes means for storing a sequence control structure including a next key value. The sequence control structure is shared by a plurality of database management system (DBMS) instances. The apparatus further includes means, responsive to a request for a new key value for a record to be added to the database, for locking for update by one of the plurality of DBMS instances, a respective host control structure associated with the one DBMS instance and the sequence control structure. Means are provided for updating the host-local control structure with a next key value from the sequence control structure and for updating the sequence control structure with a new next key value. The apparatus also includes means for storing the sequence control structure after updating the sequence control structure. Means for unlocking the sequence control structure after storing the sequence control structure, and means for unlocking the host-local control structure are also included in the apparatus. Further included are means for storing the next key value from the host-local control structure in a record added to the database.

Another embodiment of the invention is a multi-host data processing arrangement. The data processing arrangement includes at least two host data processing systems (hosts), each host including a processor arrangement and a memory coupled to the processor arrangement. A persistent storage arrangement is coupled to each host for retentive storage of a database, and the persistent storage arrangement has stored therein a sequence control structure including a next key value. Each host executes a respective database management system (DBMS) instance that provides access to the database. Each host in executing a DBMS instance and in response to a request from the DBMS instance for a new key value for a database record, obtains exclusive update access to the sequence control structure for the DBMS instance, stores a temporary copy of the next key value from the sequence control structure, updates the sequence control structure with a new next key value after storing the temporary copy, and stores the temporary copy of the next key value as the new key value of the database record after updating the sequence control structure.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a functional block diagram of a multi-host database management system in accordance with various embodiments of the invention;

FIG. 2 is a flowchart of an example process for processing an insert request in accordance with one or more embodiments of the invention;

FIGS. 3A, 3B and 3C together provide a flow diagram of a process for generating sequential key values in a database that is shared amongst multiple instances of a DBMS;

FIG. 4 is a flow diagram of an example process for handling a CREATE TABLE statement according to an example embodiment; and

FIG. 5 is a flow diagram that illustrates an example process for handling an ALTER TABLE statement in accordance with an example embodiment.

### DETAILED DESCRIPTION

The various embodiments of the invention provide for management of a database that is shared between at least two instances of a database management system (DBMS). The management approaches that are described control the generation of a monotonic sequence of key values for the DBMS instances. The system is configurable to generate a) a single monotonic sequence, b) a single monotonic sequence which cycles, or c) a sequence that includes values in different partitions. The sequence control information is recoverable in a manner such that inserts subsequent to the recovery operation do not introduce a risk of duplicate key errors. The preserving of the sequence control information in response to a first insert request obtaining a new sequence key value blocks other insert requests from access to that information for a period of time shorter than the time required for the first request to commit.

The various embodiments of the invention eliminate the need for each DBMS instance to prefix the generated key values for a shared database. The system allows inserts to be ordered such that an insert containing sequence value n always reaches the database before sequence values larger than n. This is controlled by locking an IDENTITY synchronization record, which is associated with the table until processing of the insert request is complete. The locked IDENTITY synchronization record is used to prohibit any other request from committing another insert request until the request holding the lock has committed the request, either by storing the record in retentive storage or creating an audit trail for the request in retentive storage. Once the record has been inserted into the B-tree, the lock is released to allow other requests to perform inserts.

The next sequence value is maintained in a sequence control structure in the same file as the database table data. Each DBMS instance reads the sequence control structure to obtain the next key value for an insert request. Duplicate key errors caused by inconsistent sequence and table data are not problematic because the sequence information is always consistent with the table data.

For a partitioned table, the sequence alternates between partitions, on each host, by first using partition 1, then partition 2, . . . . After the right-most partition has been chosen, the sequence goes back to partition 1. This round-robin approach attempts to distribute the sequence across all partitions and minimize contention for a particular partition. Because records may be out-of-order, each host reserves a list of key values in each partition for use by the inserts it processes. This reservation of key values is controlled using the sequence control structure that is part of every partition. The usage of the sequence control structure for partitioned tables has the same attributes as when used by IDENTITY.

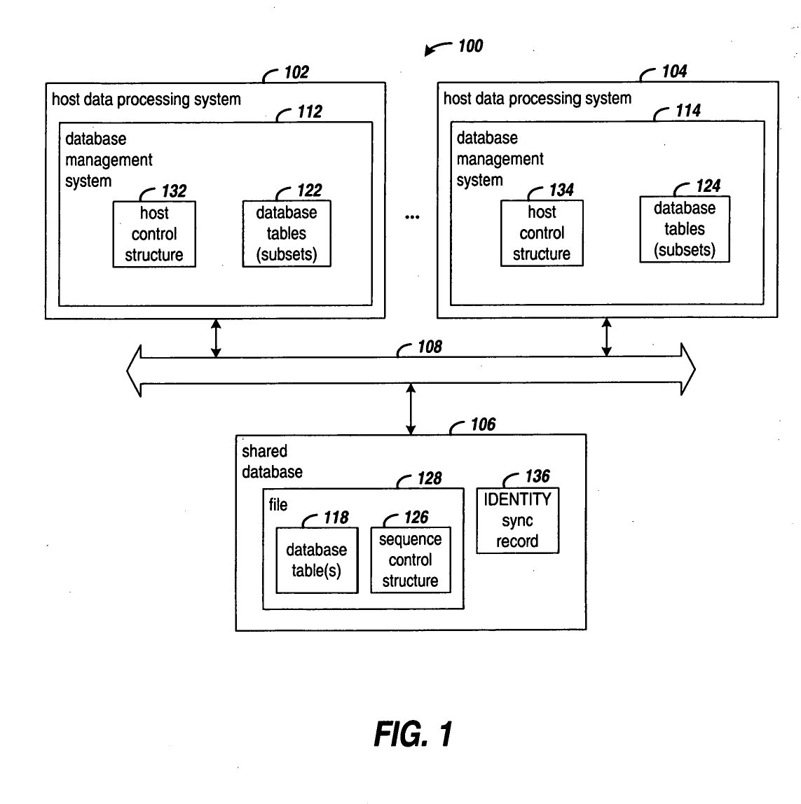

FIG. 1 is a functional block diagram of a multi-host database management system in accordance with various embodiments of the invention. The system 100 includes multiple data processing systems, for example systems 102 and 104, coupled to a shared database 106 via channel 108. Systems 102 and 104 host respective instances 112 and 114 of a DBMS. Each instance of the DBMS provides access to the shared database 106 for applications (not shown) that are also hosted in the data processing systems. An example DBMS is the RDMS (relational database management system) from Unisys Corporation. Those skilled in the art will recognize that the embodiments described herein may be adapted and used in DBMSs from other vendors.

In one embodiment, the shared database 106 includes one or more data tables 118. The database tables hold application data. As will be recognized by those skilled in the art, each table generally includes rows and columns defined by the application. Each row has one or more fields corresponding to one or more columns, and the values in the fields are the data of the database. Each row may be accessible by a key value for ease of reference, and the keys may be indexed for quick searches. A row in a database table may also be referred to as a “record.”

Depending on application requirements, each instance (112 and 114) of the DBMS stores in its allocated memory a subset (122 and 124) of the database tables. The subset of database tables present in the memory of a system depends on the data accessed by the applications hosted by that system. For example, the subset 122 of database tables in the memory of host system 102 depends on the data of database tables 118 accessed by applications executing on host system 102.

A sequence control structure 126 is maintained within the same file 128 in which the associated database table(s) 118 are stored. This allows the sequence control structure and the database table(s) to be recovered as a unit and ensures that the recovered data will not be out of sync with the next sequential key value. Because the database table(s) and sequence control structure are recovered as a unit and are maintained in the same file, the table(s) can be recovered or copied or requests rolled-back, without the table(s) and sequence control structure becoming out of sync.

While not shown, it will be understood that the file 128 in which the shared database 106 and sequence control structure 126 are stored may be logically divided into pages. Depending on the chosen size of a page and the size of a record, each page may contain several database records. Data from the shared database is cached in the memory of a host system by the DBMS instance in page units. Thus, the subsets (122 and 124) of database tables are pages from the file of the shared database.

The information in the sequence control structure is used in managing the generation of sequential key values for multiple instances of a DBMS in accordance with various embodiments of the invention. In one embodiment, the values in the sequence control structure are set using keywords on the column definition clause of an SQL CREATE TABLE statement as discussed below. The sequence control structure is a persistent data structure that exists as a data page or set of data pages in the same file that contains the table data of a database. For convenience, the sequence control structure is described as being a single data page in the file. It will be appreciated that the sequence control structure may be stored on multiple data pages if required. The sequence control structure contains several pieces of information which are present for any data page in a DBMS file. These pieces of information may include such things as the page number, page size, linkages to prior or next data pages, and so on. In addition, the sequence control structure contains the data items named and described in the following paragraphs. The names of the data items used in the following paragraphs and in the figures are used for notational purposes only.

The scs_next_value contains the next key value to be assigned to a record. The data type of the scs_next_value matches or must be coercible to the data type of the record's corresponding data type. The data type and values of the sequence depend on implementation requirements. For example, the data type of the key value can be a number, for example INTEGER, SHORT, NUMERIC, REAL, LONG, DOUBLE PRECISION, and so on. The values may be represented as a fixed or floating binary value or may be represented as a character string, encoded in ASCII, Unicode, or some other coded character set. The representation of the value may be selected according to implementation requirements. The DBMS supports incrementing or decrementing the value as appropriate. The key value may also be a structured number value such as a DATE, TIME, or TIMESTAMP for application to, for example, a scenario in which clock precision is less than the rate of inserting records. The key value may be a non-number such as an alpha-numeric product identifier where each increment alters one or more characters in the identifier; for example, incrementing A to B and then to C and so on. The increment (or decrement) of the key value follows the ordering rules for binary values or for the coded character set used to represent the key value.

The scs_increment_value specifies the amount to add to the scs_next_value in order to create the next scs_next_value. The scs_increment_value determines the sequence of generated key values. In an example case, the scs_increment_value equals 1. In the case of a monotonically decrementing key sequence, the scs_increment_value equals −1. The scs_increment_value may be any value meaningful for the user's application (e.g., −1, 1, 2, 5, 10, or 100). The scs_increment_value cannot normally be 0. A value of 0 could serve as a flag to indicate special handling of the scs_next_value.

The scs_min _value is the smallest value allowed for the scs_next_value. It may be a positive or negative value depending on the needs of the user's application.

The scs_max_value data item is the largest value allowed for the scs_next_value. The scs_max_value may be a positive or negative value depending on the needs of the user's application.

The scs_cache_value is the number of key values given to each host when the host requests a set of values. In an example usage scenario, to ensure that the sequencing of the database inserts matches the sequencing of the key values, the scs_cache_value is set to 1. Each host requesting a set of key values gets one value to use. In other usage scenarios, setting the scs_cache_value to 1 may be too stringent a serialization requirement because of the processing cost to obtain the sequence control structure for each key value (i.e., for each INSERT operation). To provide for better system throughput, the scs_cache_value may be set to 2, 5, 10, or some other number. This reduces the frequency of requests to read and update the sequence control structure. The scs_cache_value also specifies the number of key values that may be lost in the event that a host fails after it receives a set of key values and before it commits records to the database containing those values. The maximum number of possible values lost in the event that all hosts fail is the scs_cache_value multiplied by the number of hosts. In one embodiment, the key values are lost in that those key values never appear in a record in the database. In an alternative embodiment, specialized recovery code discovers and reuses the lost values.

The scs_cycle_flag indicates whether the CYCLE keyword was included in the column's definition. When the scs_cycle_flag is clear, further generating of scs_next_value stops once the scs_max_value has been assigned to a record. When the scs_cycle_flag is set, processing continues with the scs_min_value. For scs_increment_values less than 0, the situation reverses.

Each DBMS instance 112 and 114 maintains a local host control structure 132 and 134, which is used in conjunction with the sequence control structure 126 that is shared by the DBMS instances. The host control structure is used by a DBMS instance to store the next value the DBMS instance will use for the key value and to control when to obtain a new next key value from the sequence control structure. The host control structure contains the data items named and described in the following paragraphs. The names are used for notational purposes only.

The hcs_new_value is the next key value to be assigned for this host.

The hcs_increment_value is the amount to add to the hcs_new_value in order to create the next hcs_new_value. The value of the hcs_increment_value is the same as the corresponding scs_increment_value.

The hcs_max_value is the largest magnitude value allowed for hcs_new_value. The value of hcs_max_value data is the same as the corresponding scs_max_value.

The hcs_cache_count is the number of values which may be assigned by the instance of the DBMS before re-reading the sequence control structure. The hcs_cache_count is decremented by 1 each time a new key value is used. When the DBMS instance rereads the sequence control structure, the hcs_cache_count is reset to the corresponding scs_cache_value.

The hcs_resynch_flag data item is set to force the host to reread the sequence control structure. For example, the flag is set when the values in the sequence control structure are altered by an ALTER TABLE statement.

An IDENTITY sync record 136 is used to control the dispensing of sequential key values to the DBMS instances. A separate IDENTITY sync record is associated with each database table for which sequential key values are used. In various embodiments, the IDENTITY sync record may be a part of the same table, a part of the same file as the table, or part of a different shared file. The lock mechanism may vary according to implementation requirements. For example, the lock may be a database lock obtained from the DBMS′ locking facility or may be a test-and-set, mutex, or other serialization facility provided by the operating system.

Those skilled in the art will appreciate that various alternative computing arrangements, including one or more processors and a memory arrangement configured with program code, would be suitable for hosting the processes and data structures of the different embodiments of the present invention. For example, each host data processing system 102 and 104 may be a symmetric multi-processor system, a partition of a multi-processor system, a parallel processing system, a networked arrangement of computing nodes, or a single-processor system. The shared database 106 may be retentively stored in any of a variety of storage arrangements depending on application requirements, for example, network attached storage or non-networked storage devices that are shared by multiple systems. The channel 108 may be a network or an I/O channel dedicated to a set of storage devices depending on the required type of storage arrangement. For purpose of the embodiments of the invention described herein, a respective instance of a DBMS executes on each host data processing system.

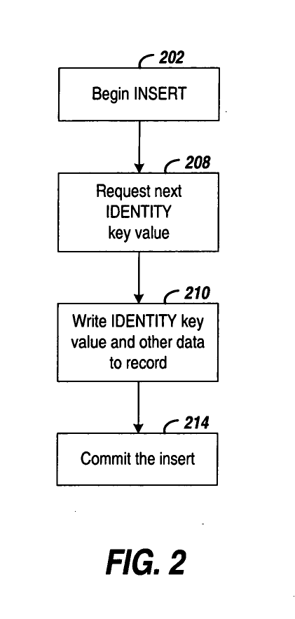

FIG. 2 is a flowchart of an example process for processing an insert request in accordance with one or more embodiments of the invention. At step 202, the insert operation commences in response to an SQL command, for example.

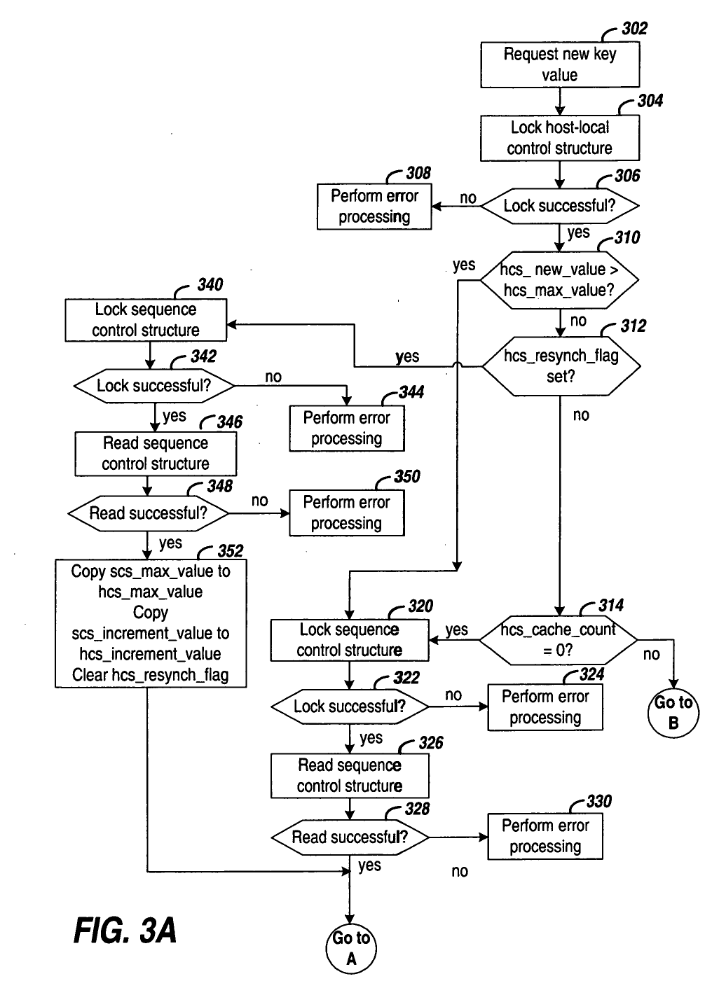

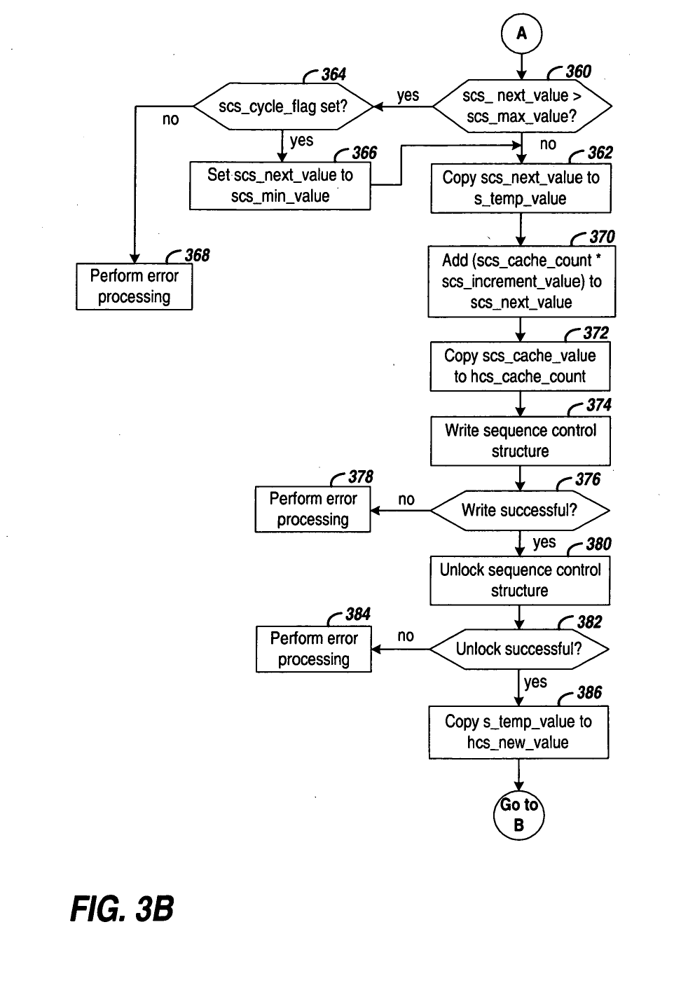

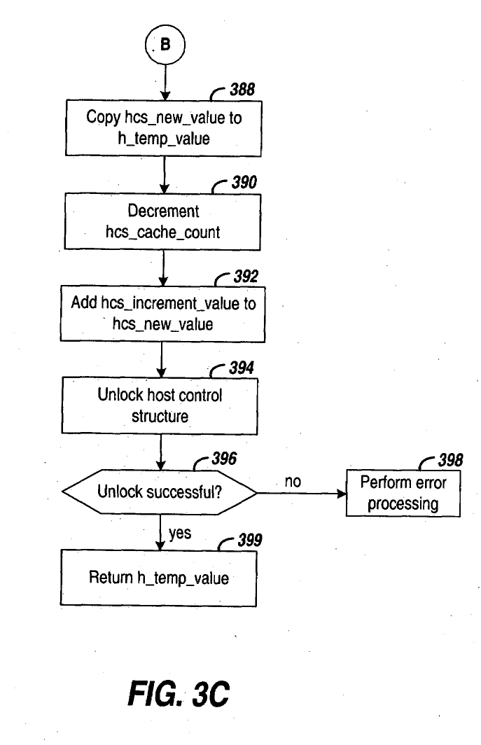

The insert requester requests the next IDENTITY key value at step 208. This processing is described in more detail in FIGS. 3A-C. In obtaining the next IDENTITY key value for the requester, the DBMS instance initiates a nested transaction which involves locking the sequence control structure via the IDENTITY synchronization record and reading and updating the next key value from the sequence control structure. The lock on the sequence control structure is released by the DBMS instance once the update to the key value in sequence control structure has been committed, which is prior to committing the update of the insert request.

At step 210, the process writes the IDENTITY key value, and any other data particular to the application, to the record to be inserted. The process releases the lock on the IDENTITY synchronization record at step 212. The insert request is committed at step 214. In committing the insert request, the data record may be stored in the proper page of the B+tree in retentive storage. Alternatively, a completion indicator may be logged to an audit trail stored in retentive storage for the insert request. The release of the lock on the IDENTITY sync record before the commit allows another record to be inserted into the table before the commit of the just-inserted record, which is acceptable because once the just-inserted record has been inserted a searcher will be blocked by the lock on the just-inserted record.

FIGS. 3A, 3B and 3C together provide a flow diagram that illustrates a processor-implemented method for generating sequential key values in a database that is shared amongst multiple instances of a DBMS. The process begins with an instance of a database management system (DBMS) executing on one of a plurality of hosts of the multi-host data processing arrangement receiving a request for a new sequential key value for a record to be added to the database at step 302. In an example environment each host may have multiple instruction processors executing independent processing threads each of which may be requesting a key value at the same time. For the purposes of this description, each processing thread is called a transaction.

At step 304 the instance of the DBMS locks its host control structure to ensure that the Atomicity, Consistency, Isolation, Durability (ACID) properties for transaction execution are preserved. Locking the local control structure marks the beginning of a section of code that cannot be logically interrupted by another transaction. The lock mechanism may vary according to implementation requirements. For example, the lock may be a database lock obtained from the DBMS′ locking facility or may be a test-and-set, mutex, or other serialization facility provided by the operating system. If a lock on the host control structure cannot be obtained, at step 306 the DBMS must abort and perform error processing at step 308 where a lock failed error code is returned to the requester and processing the request for the new key value is terminated. If the lock request is successful, processing continues with step 310.

At step 310, the hcs_new_value is checked to see if it exceeds the hcs_max_value. For purposes of illustration only, FIG. 3A assumes that the sequence of hcs_new_values is ascending. That is, the hcs_increment_value is positive. If the hcs_increment_value were negative, then the check would be reversed (i.e. check if the hcs_new_value is less than the hcs_max_value). If the hcs_new_value is within the range of allowed values, processing proceeds to step 312. If the hcs_new_value is not within the range of allowed values, the processing proceeds to step 320.

At step 312 the hcs_resynch_flag is checked to see if the flag is set. If the flag is set, the sequence control structure is reread and the values in the host-local control structure are updated according to the path beginning at step 340. If the flag is not set, processing proceeds to step 314, where the hcs_cache_count is checked to see if the allotted (cached) number of key values has been exhausted. If the hcs_cache_count is equal to 0, then the sequence control structure is reread to get the next set of values by following the path beginning at step 320. If the hcs_cache_count is not equal to 0, processing proceeds to step 388 shown in FIG. 3C.

Returning now to step 340, the sequence control structure is locked for exclusive update by the instance of the DBMS (e.g., by using the DBMS′ locking mechanism). Locking the sequence control structure marks the beginning of a nested transaction whose updates are committed to the database independently of the parent transaction. The lock on the sequence control structure is accomplished via a request to lock the IDENTITY synchronization record associated with the table against which the insert is to be processed. Once the next key value has been provided to the DBMS instance, the lock on the IDENTITY synchronization record is released to allow another requester to obtain a key value. If a lock on the sequence control structure cannot be obtained, decision step 342 directs the process to step 344 where the DBMS performs error processing, for example, returning a lock failed error code to the caller, releasing the lock of the host-local control structure (obtained at step 304), and terminating processing of the request for the new key value. If the lock request is successful, processing continues with step 346 in which the sequence control structure is read into memory. If the sequence control structure cannot be read, decision step 348 directs the process to step 350 where the DBMS performs error processing at step 350, for example, by returning an error code to the caller, releasing the lock of the host-local control structure, and terminating processing of the request for the new key value. If the reading of the sequence control structure is successful, processing continues with step 352 in which the current values from the sequence control structure are copied to the host control structure. The values that are copied are the scs_max_value and the scs_increment_value. These may have been changed using the ALTER TABLE statement which caused the hcs_resynch_flag to become set. After the values are copied, the hcs_resynch_flag is cleared and processing proceeds to step 360 shown in FIG. 3B.

Returning now to step 320, the sequence control structure is locked for exclusive update by the instance of the DBMS. If a lock on the sequence control structure cannot be obtained, then decision step 322 directs the process to step 324 to perform error processing 324, such as returning a lock failed error code to the caller, releasing the lock of the host control structure, and terminating the processing of the request for the new key value. If the lock request is successful, processing continues with step 326 in which the sequence control structure is read into memory from retentive storage. If the sequence control structure cannot be read, then decision step 328 directs the process to step 330 to perform error processing, such as returning a read-failed error code to the caller, releasing the lock of the host-local control structure, and terminating processing of the request for the new key value. If the sequence control structure read is successful, processing proceeds to step 360 shown in FIG. 3B.

At step 360 in FIG. 3B, the scs_next_value is checked to see if it exceeds the scs_max_value. FIG. 3B illustrates an example use case in which the sequence of scs_next_values is ascending. That is, the scs_increment_value is positive. In a use case in which the scs_increment_value is negative, then the check would be reversed (i.e., check if the scs_next_value is less than the scs_min_value). If the scs_next_value is within the range of allowed values, processing continues at step 362. However, if the scs_next_value is not within the range of allowed values, the process checks whether a CYCLE clause was used in the table and column definition by checking for the scs_cycle_flag at step 364. If the scs_cycle_flag is set, then the scs_next_value is set to the scs_min_value at step 366 and processing continues at step 362. If the scs_cycle_flag is not set, the process performs error processing at step 368, including, for example, returning a maximum-value-exceeded error code to the caller, releasing the lock of the host control structure, and terminating processing of the request for the new key value.

Returning now to step 362, the scs_next_value is preserved in a temporary location designated as s_temp_value. The s_temp_value is later copied to the host-local control structure to the caller as the new key value at step 386. At step 370 the scs_next_value is set to the next value in the sequence (i.e., a new next key value) by adding the scs_cache_value multiplied by the scs_increment_value to the scs_next_value. The key values form an increasing sequence when the scs_increment_value is positive and the key values form a decreasing sequence when the scs_increment_value is negative. The scs_increment_value is multiplied by the scs_cache_value to account for the set of values to be assigned to the requesting host. The increment of the scs_next_value in step 370 accounts for a set of values cached on the requesting host, in contrast to the increment of hcs_new_value at step 392 (see discussion of FIG. 3C below) which accounts for the usage of one key value.

At step 372 the scs_cache_value is copied to hcs_cache_count. The hcs_cache_count gets decremented each time a key value is used. If step 372 was arrived at through step 320, then the hcs_cache_count was 0 and must be reset to the count of available cached values. However, if step 372 was arrived at through step 340, then the scs_cache_value may have been updated as a result of an ALTER TABLE statement and the hcs_cache_count must be reset to the new count of available cached values.

At step 374 the updated sequence control structure is written back to the table's file in retentive storage. This write is the commit point for the nested transaction started at step 340. However, if the scs_cache_value is zero, the commit processing is deferred until the commit of the overall transaction. If the sequence control structure cannot be written, decision step 376 directs the process to step 378 to perform error processing, such as returning a write-failed error code to the caller, releasing the lock of the host control structure, and terminating processing of the request for the new key value. If writing of the sequence control structure is successful, processing continues with step 380 which releases the lock of the sequence control structure to end the nested transaction. However, if the scs_cache_value is zero, the lock release is deferred until the commit of the overall transaction. If the lock of the sequence control cannot be released, decision step 382 directs the process to step 384 to perform error processing, such as returning a lock-release-failed error code to the caller, releasing the lock of the host control structure, and terminating processing of the request for the new key value. If the lock release is successful, processing continues with step 386 in which the next key value from s_temp_value is copied to the hcs_new_value. Processing then proceeds to step 388 in FIG. 3C.

At step 388, the hcs_new_value is copied to a temporary location designated as h_temp_value. This value may eventually be returned to the caller as the new key value at step 399. At step 390 the hcs_cache_count is decremented to account for the fact that the key value has been used. The hcs_cache_count toggles between 1 and 0 in a use case in which all key values must be assigned sequentially across all hosts. The hcs_cache_count counts down from the initial scs_cache_value to 0 in the use case in which each host has a set of values (more than one key value) to use before re-reading the sequence control structure.

At step 392 the hcs_new_value is set to the next value in the sequence by adding the hcs_increment_value to the hcs_new_value. The key values form an increasing sequence when the hcs_increment_value is positive and the key values form a decreasing sequence when the hcs_increment_value is negative. At step 394 the lock of the host-local control structure is released. If the lock of the host control structure cannot be released, then decision step 396 directs the process to perform error processing at step 398, including, for example, returning a lock-release-failed error code to the caller and terminating processing of the request for the new key value. If the lock release is successful, processing continues with step 399 in which the new key value, temporarily saved in h_temp_value, is retuned to the requester.

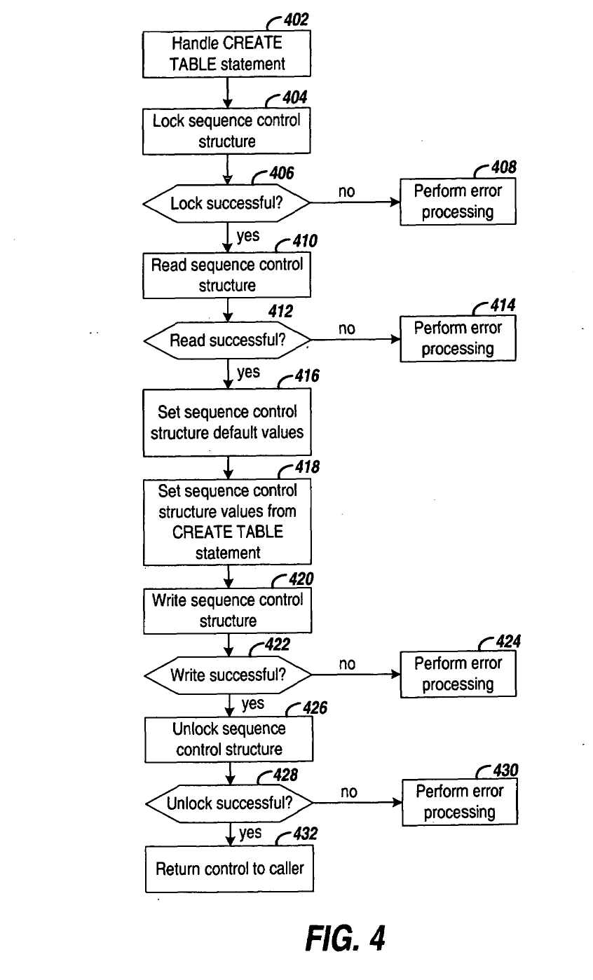

FIG. 4 is a flow diagram which illustrates an example process for handling a CREATE TABLE statement according to an example embodiment. An IDENTITY clause in the column definition of a CREATE TABLE statement is used to initialize values in the sequence control structure. The values in the sequence control page are set using special keywords on the column definition. An IDENTITY clause has the following format:

IDENTITY (generator-options)
generator-options
[START WITH start-value]
[INCREMENT BY increment-value]
[MINVALUE minimum-value | NO MINVALUE | NOMINVALUE]
[MAXVALUE maximum-value | NO MAXVALUE | NOMAXVALUE]
[CYCLE | NO CYCLE | NOCYCLE]
[CACHE [number-of-values | DYNAMIC] | NO CACHE | NOCACHE]

The following is an example CREATE TABLE statement having an IDENTITY clause:

```
CREATE TABLE my_messages
(Msg_id : NUMERIC(21,0) IDENTITY (START WITH 1000
              INCREMENT BY 10
              MAXVALUE 40000
              ) NOT NULL PRIMARY KEY,
    Msg_text : CHARACTER(2000) NOT NULL)
```

The process is initiated at step 402 in response to encountering an IDENTITY clause in a CREATE TABLE SQL statement. The parsing and other handling of the CREATE TABLE statement can be accomplished using various techniques known to those skilled in the art. Alternate embodiments may use different syntactical elements to convey the identity control information.

At step 404, the sequence control structure is locked for exclusive update using a locking mechanism as previously described. If a lock on the sequence control structure cannot be obtained, decision step 406 the DBMS directs the process to step 408 to perform error processing, such as returning a lock-failed error code to the caller and terminating processing of the CREATE TABLE statement. If the lock request is successful, processing continues with step 410 in which the sequence control structure is read into memory from retentive storage. If the sequence control structure cannot be read, then decision step 412 directs the process to perform error processing at step 414, such as returning a read-failed error code to the caller and terminating processing of the CREATE TABLE statement. If the reading of the sequence control structure is successful, processing continues with step 416. As an alternative to steps 404 through 412, a DBMS may allow a page to be created in memory without first reading it from the table's file. In the case of CREATE TABLE statement processing, where no other transactions can be creating the same table at the same time, creating the structure in memory first is a preferred method.

At step 416 the default values for the data items in the sequence control structure are set. Since all the IDENTITY clauses in the CREATE TABLE statement are optional, the values are initialized to default values and subsequently updated for any IDENTITY clauses. In an example embodiment, the default values for the sequence control structure are as follows. The scs_next_value is set to 1 if the column's data type is a number, for example INTEGER, SHORT, NUMERIC, REAL, LONG, DOUBLE PRECISION, and so on. The scs_next_value is set to 0001-01-01 00:00:00 if the column's data type is a DATE, TIME, or TIMESTAMP. The scs_next_value is set to A if the column's data type is CHARACTER [VARYING]. The scs_increment_value is set to 1. The scs_min_value is set to the smallest value allowed for the column's data type, which is equivalent to a NO MINVALUE clause. The scs_max_value is set to the largest value allowed for the column's data type minus the scs_increment_value, which is equivalent to a NO MAXVALUE clause. Since scs_next_value is unconditionally incremented, the scs_next_value needs to be able to represent one increment past the maximum allowed value. The scs_start_value is set to the scs_next_value. The scs_cache_value is set to the maximum number of records that can be stored on the primary key's index page corresponding to the table. The scs_cycle_flag is cleared to indicate no cycling of the key values.

At step 418 the default values in the sequence control structure are updated with values from any IDENTITY clauses in the CREATE TABLE statement. The scs_next_value is set to the value of the START WITH clause. If the START WITH clause is not present, then the scs_next_value is set to the value of the MINVALUE clause if the sequence is increasing, and the scs_next_value is set to the value of the MAXVALUE clause if the sequence is decreasing. The scs_increment_value is set to the value on the INCREMENT clause, the scs_min_value is set to the value on the MINVALUE clause, and the scs_max_value is set to the value on the MAXVALUE clause. The scs_cache_value is set to the value on the CACHE clause. However, if the CACHE clause is CACHE DYNAMIC the default value is not changed. If NO CACHE is specified, then the scs_cache_value is set to 0 which indicates that that nested steps are not to be used. The scs_cycle_flag is set if the CYCLE keyword is present.

At step 420 the updated sequence control structure is written back to the table's file in retentive storage. If the sequence control structure cannot be written to retentive storage, decision step 422 directs the process to perform error processing at step 424, such as returning a write-failed error code to the caller and terminating processing of the CREATE TABLE statement. If the sequence control structure write is successful, processing continues with step 426 in which the lock of the sequence control structure is released. If the lock of the sequence control structure cannot be released, then decision step 428 directs the process to perform error processing at step 430, such as returning an unlock-failed error code to the caller and terminating processing of the CREATE TABLE statement. If the lock release is successful, control is returned to the caller at step 432.

When an instance of a DBMS first creates a table via a CREATE TABLE statement having an IDENTITY clause, a host control structure is created in memory and the hcs_resynch_flag is set. When the instance of the DBMS requests the next key value for a new database record, the host control structure is populated with values from the sequence control structure.

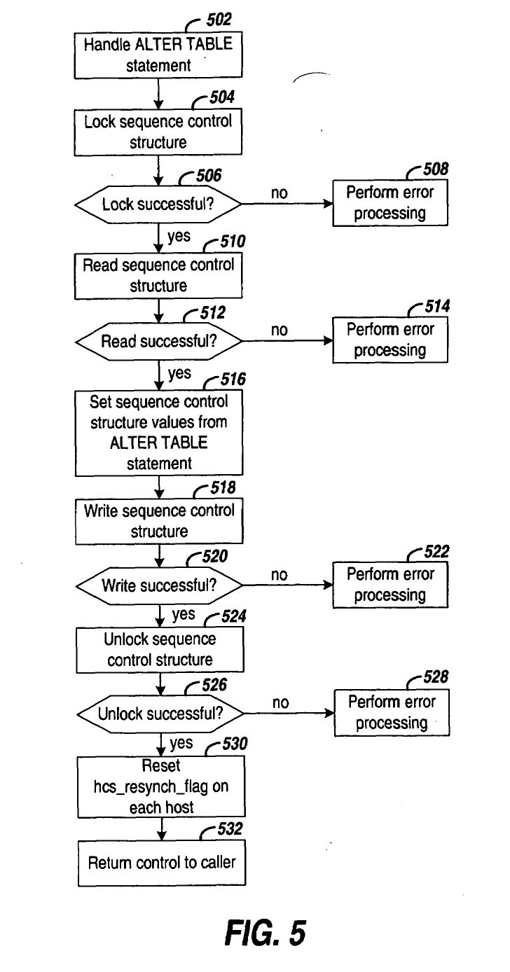

FIG. 5 is a flow diagram that illustrates an example process for handling an ALTER TABLE statement in accordance with an example embodiment. As with the CREATE TABLE statement, the generator options related to the IDENTITY clause on the column definition in an ALTER TABLE statement control the sequence control structure values. Using the ALTER TABLE statement, any of the values in the sequence control structure may be altered. The syntax for ALTER TABLE is:

ALTER TABLE table-name CHANGE column-name
generated-identity-clause
generated-identity-clause
RESTART WITH restart-value
SET INCREMENT BY increment-value
SET MINVALUE minimum-value | NO MINVALUE | NOMINVALUE
SET MAXVALUE maximum-value | NO MAXVALUE |
NOMAXVALUE
SET CYCLE | NO CYCLE | NOCYCLE
SET { CACHE [number-of-values | DYNAMIC] | NO CACHE |
NOCACHE }

The clauses are the same as for the CREATE TABLE statement with the exception of the RESTART clause. CREATE TABLE has a START WITH clause which is used to set the key value to be first used. The RESTART WITH clause alters the scs_next_value with the next key value to use. Alternative embodiments may use different syntactical elements to convey the identity control information.

The process for handling the ALTER TABLE statement is invoked at step 502 when the generated-identity clause is found on an ALTER TABLE statement. The parsing and other handling of the ALTER TABLE statement can be accomplished using various techniques known to those skilled in the art. At step 504 the sequence control structure is locked for exclusive update using a locking mechanism as previously described. If a lock on the sequence control structure cannot be obtained, decision step 506 directs the process to perform error processing at step 508, such as returning a lock-failed error code to the caller and terminating processing of the ALTER TABLE statement. If the lock request is successful, processing continues with step 510 in which the sequence control structure is read into memory. If the sequence control structure cannot be read, then decision step 512 directs the process to perform error processing at step 514, such as returning a read-failed error code to the caller and terminating processing of the handle ALTER TABLE statement. If reading of the sequence control structure is successful, processing continues with step 516.

At step 516 the values in the sequence control structure are updated with values from those generated_identity clauses present in the ALTER TABLE statement. The scs_next_value is set to the value of the RESTART WITH clause, the scs_increment_value is set to the value on the INCREMENT clause, and the scs_min _value is set to the value on the MINVALUE clause. If NO MINVALUE is specified, the scs_min_value is set to the smallest value that can be represented by the column's data type. The scs_max_value is set to the value on the MAXVALUE clause, or to the largest value that can be represented by the column's data type minus the scs_increment_value if NO MAXVALUE is specified. The scs_next_value can never exceed a value that can be stored in the column since the invention unconditionally increments the scs_next_value. The scs_cache_value is set to the value on the CACHE clause. If the CACHE clause is CACHE DYNAMIC, then the scs_cache_value is set to the maximum number of records that can be stored on the primary key's index page corresponding to the table. If NO CACHE is specified, then the scs_cache_value is set to 0 which indicates that that nested steps are not to be used. The scs_cycle_flag is set if the CYCLE keyword is present or is cleared if the NO CYCLE keyword is present.

At step 518 the updated sequence control structure is written to the table's file in retentive storage. If the sequence control structure cannot be written, then decision step 520 directs the process to step 522 for error processing such as returning a write error code to the caller and terminating processing of the ALTER TABLE statement. If the sequence control structure write is successful, processing continues with step 524 in which the lock of the sequence control structure obtained at step 504 is released. If the lock of the sequence control structure cannot be released, then decision step 526 directs the process to perform error processing at step 528 such as returning an unlock-failed error code to the caller and terminating processing of the ALTER TABLE statement. If the unlock was successful, then processing continues with step 530 in which the hcs_resynch_flag is set on each host. This may be accomplished in many ways such as using techniques for broadcasting cache invalidate messages as are known to those skilled in the art. Control is returned to the caller in step 532 after the hcs_resynch_flags are set on each host.

Those skilled in the art will appreciate that various alternative computing arrangements, including one or more processors and a memory arrangement configured with program code, would be suitable for hosting the processes and data structures of the different embodiments of the present invention. In addition, the processes may be provided via a variety of computer-readable media or delivery channels such as magnetic or optical disks or tapes, electronic storage devices, or as application services over a network.

The present invention is thought to be applicable to a variety of software systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A processor-implemented method for generating key values in a database that is shared in a multi-host data processing arrangement, comprising:
storing a sequence control structure including a next key value;
providing mutually exclusive update access to the sequence control structure by a plurality of instances of a database management system (DBMS) executing on the multi-host data processing arrangement; and for a request for a new key value for a database record, storing a temporary copy of the next key value from the sequence control structure, updating the sequence control structure with a new next key value after storing the temporary copy, and storing the temporary copy of the next key value as the new key value of the database record after updating the sequence control structure.

2. The method of claim 1, wherein the updating includes committing the new next key value to retentive storage prior to the storing of the temporary copy of the next key value as the new key value of the database record.

3. The method of claim 1, wherein the storing includes storing the sequence control structure in a database file in which the record is to be added to the database.

4. The method of claim 1, further comprising:
storing an increment value in the sequence control structure; and wherein the updating of the sequence control structure with a new next key value includes adding the increment value to the next key value.

5. The method of claim 4, wherein the storing of the increment value is in response to a name and value specified in a structured query language (SQL) CREATE TABLE statement.

6. The method of claim 4, further comprising:
wherein the increment value is negative;
storing a minimum key value in the sequence control structure;
storing a maximum key value in the sequence control structure; and
in response to the new next key value being less than the minimum key value after the adding of the increment value, storing the maximum key value as the new next key value.

7. The method of claim 4, further comprising: wherein the increment value is positive; storing a minimum key value in the sequence control structure; storing a maximum key value in the sequence control structure; and in response to the new next key value being greater than the maximum key value after the adding of the increment value, storing the minimum key value as the new next key value.

8. The method of claim 4, further comprising: wherein the increment value is negative; storing a cycle flag value in the sequence control structure; storing a minimum key value in the sequence control structure; storing a maximum key value in the sequence control structure; in response to the cycle flag value having a first value and the new next key value being less than the minimum key value after the adding of the increment value, storing the maximum key value as the new next key value; and in response to the cycle flag value having a second value and the new next key value being less than the minimum key value after the adding of the increment value, stopping generation of new key values for subsequent requests.

9. The method of claim 8, wherein the storing of the cycle flag value, the minimum key value, and the maximum key value is in response to respective name-value pairs specified in a structured query language (SQL) CREATE TABLE statement.

10. The method of claim 4, further comprising: wherein the increment value is positive; storing a cycle flag value in the sequence control structure; storing a minimum key value in the sequence control structure; storing a maximum key value in the sequence control structure; in response to the cycle flag value having a first value and the new next key value being greater than the maximum key value after the adding of the increment value, storing the minimum key value as the new next key value; and in response to the cycle flag value having a second value and the new next key value being greater than the maximum key value after the adding of the increment value, stopping generation of new key values for subsequent requests.

11. The method of claim 1, further comprising: storing a key cache value in the sequence control structure; storing an increment value in the sequence control structure; and wherein the updating of the sequence control structure with a new next key value includes adding a product of the increment value and the key cache value to the next key value.

12. The method of claim 11, wherein the storing of the key cache value and the increment value is in response to respective name-value pairs specified in a structured query language (SQL) CREATE TABLE statement.

13. The method of claim 11, further comprising: storing the key cache value in respective host control structures for the DBMS instances; storing the increment value in the host control structures; wherein for the request for a new key value being by one of the DBMS instances, adding the increment value from the host control structure of the one DBMS instance to the temporary copy of the next key value resulting in a DBMS-instance next key value, and storing the DBMS-instance next key value in the host control structure for the one DBMS instance; wherein, for each of a number of subsequent requests for new key values needed for database records by the one DBMS instance, the number of subsequent new key values being equal to the key cache value in the respective host control structure, the DBMS instance uses the DBMS-instance next key value from the respective host control structure and updates the DBMS-instance next key value using the increment value in the host control structure; and in response to the number of subsequent requests for new key values exceeding the key cache value in the respective host control structure, accessing the sequence control structure for the next key value.

14. The method of claim 1, wherein the storing of the sequence control structure is in response to a structured query language (SQL) CREATE TABLE statement.

15. The method of claim 1, further comprising updating the sequence control structure in response to a structured query language (SQL) ALTER TABLE statement.

16. An apparatus for generating key values in a database that is shared in a multi-host data processing arrangement, comprising: means for storing a sequence control structure including a next key value, wherein the sequence control structure is shared by a plurality of database management system (DBMS) instances; means, responsive to a request for a new key value for a record to be added to the database, for locking for update by one of the plurality of DBMS instances, a respective host control structure associated with the one DBMS instance and the sequence control structure; means for updating the host-local control structure with a next key value from the sequence control structure; means for updating the sequence control structure with a new next key value; means for storing the sequence control structure after updating the sequence control structure; means for unlocking the sequence control structure after storing the sequence control structure; means for unlocking the host-local control structure; and means for storing the next key value from the host-local control structure in a record added to the database.

17. A multi-host data processing arrangement, comprising: at least two host data processing systems (hosts), each host including a processor arrangement and a memory coupled to the processor arrangement; a persistent storage arrangement coupled to each host for retentive storage of a database, wherein the persistent storage arrangement has stored therein a sequence control structure including a next key value; wherein each host executes a respective database management system (DBMS) instance that provides access to the database, and each host in executing a DBMS instance and in response to a request from the DBMS instance for a new key value for a database record, obtains exclusive update access to the sequence control structure for the DBMS instance, stores a temporary copy of the next key value from the sequence control structure, updates the sequence control structure with a new next key value after storing the temporary copy, and stores the temporary copy of the next key value as the new key value of the database record after updating the sequence control structure.

18. The data processing arrangement of claim 17, wherein each host in updating the sequence control structure, commits the new next key value to retentive storage prior to the storing of the temporary copy of the next key value as the new key value of the database record.

19. The data processing arrangement of claim 17, wherein the sequence control structure includes an increment value, and each host in updating the sequence control structure adds the increment value to the next key value.

20. The method of claim 19, wherein each host in executing the DBMS instance stores the increment value in response to a name and value specified in a structured query language (SQL) CREATE TABLE statement.
